(19) United States
(12) Patent Application Publication
(10) Pub. No.: US 2014/0188737 A1
(43) Pub. Date: Jul. 3, 2014

(54) AUTOMATED MONEY ALLOCATION SYSTEM AND METHOD

(71) Applicants: Omar Salah, Los Angeles, CA (US); Lisa Dilenschneider, Los Angeles, CA (US)

(72) Inventors: Omar Salah, Los Angeles, CA (US); Lisa Dilenschneider, Los Angeles, CA (US)

(21) Appl. No.: 14/145,997

(22) Filed: Jan. 1, 2014

Related U.S. Application Data
(60) Provisional application No. 61/748,103, filed on Jan. 1, 2013.

(51) Int. Cl. G06Q 20/38; G06Q 20/40

(52) U.S. Cl. CPC G06Q 20/382; G06Q 20/4012
USPC 705/72; 705/44

(57) ABSTRACT

Disclosed is a method and system for controlling allocation and transfer of funds among multiple recipients. The method includes receiving registration information from a user, storing the registration information, assigning to the user a primary account, and multiple sub-accounts linked to the primary account in a waterfall hierarchy, receiving recipient account information to be linked to the sub-accounts, receiving a set of selectively repeating predefined rules corresponding to the sub-accounts. The rules include a funds allocation rule for allocating a portion of funds deposited in the primary account into the sub-accounts, and determining if allocated funds in the sub-accounts has hit the allocated target, a payment transfer rule for transferring the allocated target funds in the sub-accounts to the recipient account, and an authentication verification rule for verifying authentication of the user for updating the rules corresponding to the sub-accounts.

### CROSS REFERENCE TO RELATED APPLICATION

This Utility patent applications claims priority to and benefit of U.S. Provisional patent application Ser. No. 61/748,103 filed on Jan. 1, 2013, and entitled “AUTOMATED MONEY ALLOCATION SYSTEM” under 35 U.S.C. 119(e). The contents of above mentioned provisional application is fully incorporated herein for all purposes.

### FIELD OF THE INVENTION

This invention relates to a method and system for distribution of funds and, more specifically, the present invention relates to a method and system that controls allocation and transfer of funds among multiple recipients using a user defined set of rules.

### BACKGROUND OF THE INVENTION

The generally accepted definition of money is that ‘money’ has two major attributes: a value and a medium of exchange. While it is easy to transfer money to another entity in today's world by electronic transfer, it is often difficult to control the allocation and scheduled transfer of money among multiple recipients.

Typically, when a person sets aside money for a specific purpose, he or she opens a separate account so that some money may be steadily saved into that account for that specific purpose. For example, the person may decide to save up to pay for a new car. In order to prevent oneself from diverting the saved money to other purchases, the user may typically open a separate savings account to separate the money for purchase of the car from other money used for other purposes. Again, if in addition to this, the user wants to save up for a house, the user may have to open additional separate accounts as a way of keeping track of progress in relation to achieving his saving goal for the house. This approach does have the shortcomings. For example, while the user knows that the money in the savings account is for the car, the user may always withdraw the money and use it for other purposes leaving the desired saving goal unfulfilled. Further, opening of the multiple account provide some benefit to give an idea to the user as to where the money should be allocated, a problem with opening and managing multiple accounts is that the financial institutions (preferably banks) often charge money to maintain each open account, this discourages opening of many accounts. Further, if the user is able to do so, the user may have to remember separate user names, passwords, account numbers etc. corresponding to each active account, and so practically it is difficult for the user to own multiple accounts.

As is well known, the distribution of money among multiple recipients on a transparent and impartial basis is typically carried out using manual calculations and transfers. However, such manual allocation and transfer doesn't assure the potential recipients a fair, timely and equitable distribution of money.

Thus, the present invention seeks to find a better way to allocate and control flow of money. What is a needed is an improved money allocation system and method that can assist individuals/businesses/other organizations to automatically control allocation and transfer of funds/money among multiple recipients using a user defined set of rules.

### BRIEF SUMMARY OF THE INVENTION

In accordance with aspects of the present invention, there is provided methods and systems according to the appended claims.

In accordance with other aspects of the present invention, there is provided a simple, more reliable, and more elegant solution for individuals/businesses/other organizations who want to automatically control allocation and transfer of fund/money among multiple recipients using a set of rules defined by the user or a person authorized by him.

It is an object of the present invention to provide a method and system for automatically and reliably distributing funds electronically. This distribution can occur from an individual to individual or from a business to a business or between an individual and a business.

A further object of the present invention is to provide a method and system that controls allocation and transfer of funds among multiple recipients using a set of rules, such allocation and transfer may be handled as one-time transactions or may be handled as ongoing transactions. For instance, for a business, payment of monthly rent is usually an ongoing transaction, whereas payment for new furniture could be considered as a one-time transaction.

According to an aspect of the present invention there is provided a method for controlling allocation and transfer of funds among multiple recipients. The method includes receiving, at a web server, registration information from a user; storing, in one or more databases the registration information, wherein each of the databases being communicatively linked to the web server; assigning, to the user a primary account, and multiple sub-accounts communicatively linked with the primary account in a waterfall hierarchy; receiving from the user, one or more recipient account information to be linked to each of the sub-accounts; receiving from the user, a set of selectively repeating predefined rules corresponding to each of the sub-accounts, the set of predefined rules includes a funds allocation rule for allocating a portion of funds deposited in the primary account into each of the sub-accounts until the funds deposited in the primary account is fully allocated, and determining if allocated funds has hit the allocated target for each of the sub-accounts, a payment transfer rule for transferring the allocated target funds in each of the sub-accounts to the recipient account based on the determination, and a predetermined scheduled date, and an authentication verification rule for verifying authentication of the user for selectively updating the set of predefined rules corresponding to each of the sub-accounts.

According to another aspect there is provided a method for distributing funds among recipients. The method being carried out by a number of different entities, including a web server executing a web application configured thereon, one or more databases communicatively linked to the web server, a computing device for accessing the server presenting visualizations for display on the computing device, with each of the entities communicating over a communication network. The method includes receiving, at a web server, registration information from a user; storing, in one or more databases the registration information associated with the user, wherein each of the databases being communicatively linked to the web server; assigning, to the user a primary account, and multiple sub-accounts communicatively linked to the primary account in a waterfall hierarchy; receiving from the user, one or more recipient account information to be linked to each of the sub-accounts; receiving from the user, a set of selectively repeating predefined rules corresponding to each of the sub-accounts, wherein the set of predefined rules includes a funds allocation rule for allocating a portion of funds deposited in the primary account into each of the sub-accounts until the funds deposited in the primary account is fully allocated, and determining if allocated funds has hit the allocated target for each of the sub-accounts, a payment transfer rule for transferring the allocated target funds in each of the sub-accounts to the recipient account based on the determination, and a predetermined scheduled date, and an authentication verification rule for verifying authentication of the user for selectively updating the set of predefined rules corresponding to each of the sub-accounts.

According to another aspect there is provided a system comprising a web server, that includes a data processor, and a computer readable memory having computer readable instructions encoded therein that, when executed by the data processor presents visualizations for display on a computing device associated with a user; one or more databases communicatively linked to the web server for storing registration information received from the user; wherein each of the visualizations depicting a method for distributing funds among recipients. The method performs following operations: assigning, to the user a primary account, and sub-accounts communicatively linked with the primary account in a waterfall hierarchy, receiving from the user, one or more recipient account information to be linked to each of the sub-accounts, receiving from the user, a set of selectively repeating predefined rules corresponding to each of the sub-accounts, the set of predefined rules comprising a funds allocation rule for allocating a portion of funds deposited in the primary account into each of the sub-accounts until the funds deposited in the primary account is fully allocated, and determining if allocated funds has hit the allocated target for each of the sub-accounts, a payment transfer rule for transferring the allocated target funds in each of the sub-accounts to the recipient account based on the determination, and a predetermined scheduled date, and an authentication verification rule for verifying authentication of the user for selectively updating the set of predefined rules corresponding to each of the sub-accounts.

To the accomplishment of the above and related objects, this invention may be embodied in the form illustrated in the accompanying drawings, attention being called to the fact, however, that the drawings are illustrative only, and that changes may be made in the specific construction illustrated and described within the scope and spirit of the present invention.

### BRIEF DESCRIPTION OF THE DRAWINGS

The present invention will become fully appreciated as the same becomes better understood when considered in conjunction with the accompanying drawings, and wherein:

FIG. 1 is flow diagram illustrating a method for controlling allocation and transfer of funds among multiple recipients, according to an exemplary embodiment;

FIG. 2 is a flow diagram illustrating detailed execution of a set of selectively repeating predefined rules corresponding to each of the sub-accounts, according to an exemplary embodiment;

FIG. 3 is an example flow diagram illustrating a method for allocation and transfer of funds to a recipient on determining if the allocated funds have hit the allocated target;

FIG. 4 is an example flow diagram illustrating a method for allocation and transfer of funds to recipients on a scheduled date; and

FIG. 5 is an example flow diagram illustrating a method as to how a funds allocation rule enables a terminating sub-account of the sub-accounts to transfer funds into higher priority sub-accounts to ensure each of higher priority sub-accounts hit the allocated target fund.

### DETAILED DESCRIPTION OF THE INVENTION

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described. The disclosed embodiments are merely exemplary of the invention, which may be embodied in various forms.

Embodiments of the present invention are directed towards a system and method for controlling allocation and transfer of funds among multiple recipients. In accordance with an exemplary embodiment of the present invention, a method for controlling allocation and transfer of funds among multiple recipients includes receiving, at a web server, registration information from a user. The registration information comprises user identification information.

In accordance with the same embodiment, the method includes storing, in one or more databases the registration information associated with the user, wherein each of the databases being communicatively linked to the web server.

In accordance with the same embodiment, the method includes assigning, to the user a primary account, and multiple sub-accounts communicatively linked to the primary account in a waterfall hierarchy. The primary account is configured to receive funds from one or more payment sources preferable including but not limited to a prepaid card, a debit card, a credit card, and bank account. The primary account serve to automatically transfer funds into each of the sub accounts based on the funds allocation rule.

In accordance with the same embodiment, the method includes receiving from the user, one or more recipient account information to be linked to each of the sub-accounts. The recipient account information may relate an individual, a business, an organization, and the like.

In accordance with the same embodiment, the method includes receiving from the user, a set of selectively repeating predefined rules corresponding to each of the sub-accounts. The set of predefined rules include a funds allocation rule for allocating a portion of funds deposited in the primary account into each of the sub-accounts until the funds deposited in the primary account is fully allocated, and determining if allocated funds has hit the allocated target for each of the sub-accounts. The determination if allocated funds has hit the allocated target for each of the sub-accounts either terminate further allocation of funds in each of the sub-accounts or repeats the funds allocation rule each time a funds is deposited in the primary account. The funds allocation rule further enables a terminating sub-account of the sub-accounts to transfer funds into one or higher priority sub-accounts to ensure each of higher priority sub-accounts hit the allocated target fund.

The set of selectively repeating predefined rules corresponding to each of the sub-accounts includes a payment transfer rule for transferring the allocated target funds in each of the sub-accounts to the recipient account based on the determination, and a predetermined scheduled date.

The set of selectively repeating predefined rules further includes an authentication verification rule for verifying authentication of the user for selectively updating the set of predefined rules corresponding to each of the sub-accounts. The authentication verification rule when implemented performs following operations: transmits a message comprising a randomly generated verification code to the registered user, and one or more users authorized to update the set of predefined rules corresponding to each of the sub-accounts, receiving, response to the message from the registered users and the users authorized to update the set of predefined rules, mapping, the responses received from each of the registered users and the users authorized to update the set of predefined rules for compliance with the authentication verification rule, and allowing, the registered users and the authorized users to update the set of predefined rules on determining compliance.

According to the same embodiment, the method further includes assigning user authentication information to the user upon registration with the web server, where the user authentication information comprising one or more of: a username, a password, and a PIN.

At high level, a user signs up for an account with the present system that consists of a web server. The user is assigned a primary account, hereinafter referred as a sweep bank account, and one or more subaccounts, hereinafter referred to as escrow accounts. The escrow accounts in general function as reserve accounts, allowing money to be steadily collected and set aside for specific budgetary purposes, which in the case of small business, would likely be rent expense, loan payments, and other critical bills and fees for goods and services, before the funds are ultimately transferred to the designated third party recipient account.

The registered users are able to define a set of rules corresponding to each escrow account, and are enabled to link one or more recipient bank account to each escrow account. The predefined set of rules comprises of a funds allocation rule/instructions, a payment transfer rule, and an authentication verification rule. Funds allocation instructions dictate what percentage of each deposit in the sweep bank account is allocated to the corresponding escrow account. The funds allocation instructions may also specify a target funds for each of the escrow accounts, so that once that target funds is reached in the escrow accounts, no additional funds are allocated into the escrow account until the payment instructions is executed. The payment transfer instructions dictate when the balance in the escrow account will be transferred into the linked recipient bank account, either immediately upon deposit or on a specified date. Each of defined rules is set to repeat unless the user specifies that the rule should not repeat. The authentication verification rule helps verify authentication of the user to selectively update the predefined rules corresponding to each of the sub-accounts.

The user may select the name(s) of the user whose permission is needed to modify/update each rule. So, when the user attempts to edit an existing rule, the rule can be changed with the permission of all users whose authorization is defined. If the user attempting to change a rule is the only user on that account whose authorization is needed, that user may simply edit and save the updated rule. If the account holder attempting to change a rule does not have the authority to change the rule alone, then the system may generate and send an e-mail or other notifications requesting approval for the change from all users whose authorization is required. The system simultaneously sends a text message containing randomly generated verification code, which the authorized users enter into their email response in order to verify their identity.

The authorized users may: (i) click “Reply” to the e-mail, (ii) select either “Yes” or “No”, and (iii) enter the verification code as well as any feedback, if needed in the body of a reply e-mail. Once the system receives responses from all the authorized users, the system tallies/maps the results. If the response of each required party is “Yes,” the rule is automatically changed. If any of the users chose “No,” the rule may remain as is, and the user may be notified about the results of the voting. While defining the rules, the users are enabled to indicate whose permission is needed to add new rules or modify existing rules, so that rules can be added or modified when all the authorized users grants approval. All the rules are generally prioritized in a waterfall hierarchy such that the rule at the top tier is fulfilled first, and subsequent to that the next rule and so on in series, until 100% of the funds is allocated.

As the user assigns a percentage of the deposit to each escrow account, the last escrow account in the waterfall makes up the difference so that all escrow accounts equal 100% of the deposited fund.

The system is generally implemented using a number of different entities, including a web server executing a web application configured thereon, one or more databases communicatively linked to the web server, a computing device, preferably personal computer, laptop, smart phone and the like associated with the user for accessing the server that presents visualizations for display on the computing device. Each of the entities communicates over a communication network preferably but not limited to internet, Wi-Fi, and the like.

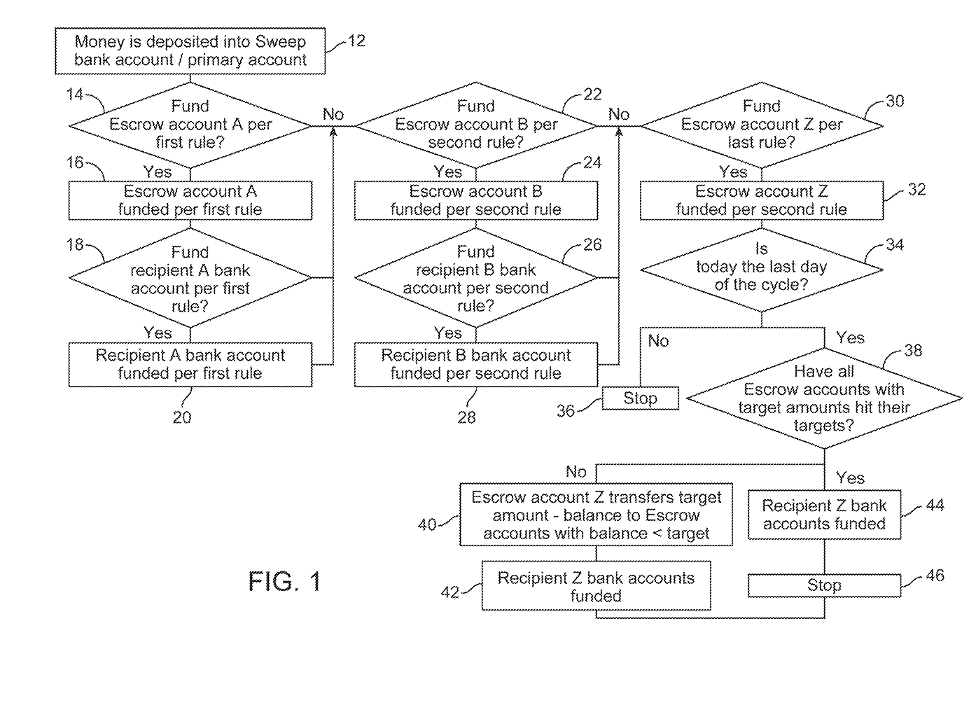

Though not detailed herein, it is to be understood that the web server includes a data processor, and a computer readable memory having computer readable instructions in the form of the web application encoded therein that, when executed by the data processor presents the visualizations for display on the computing device of the user. The databases associated with the web server are meant for storing preferably registration information received from the user. The computer readable instructions or the application are configured to implement a method for distributing funds among multiple recipients which will now be described in detail with reference to FIGS. 1-5.

Referring to FIG. 1, there is shown a flow diagram illustrating a method for controlling allocation and transfer of funds among multiple recipients, according to an exemplary embodiment. At step 12, one or more revenue sources may deposit funds into the primary account/the sweep bank account.

As can be appreciated by one skilled in the art, the funds deposited into the sweep account is then automatically dispersed among multiple sub-accounts/escrow accounts linked with the sweep account at steps 14, 22 and 30 based on a funds allocation rule from the pre-determined set of rules defined by the user. It should be understood that, for clarity of illustration, only three escrow accounts are shown in FIG. 1. However, the implementation of the method is not limited to only three escrow accounts, and may be practiced with any number of escrow accounts.

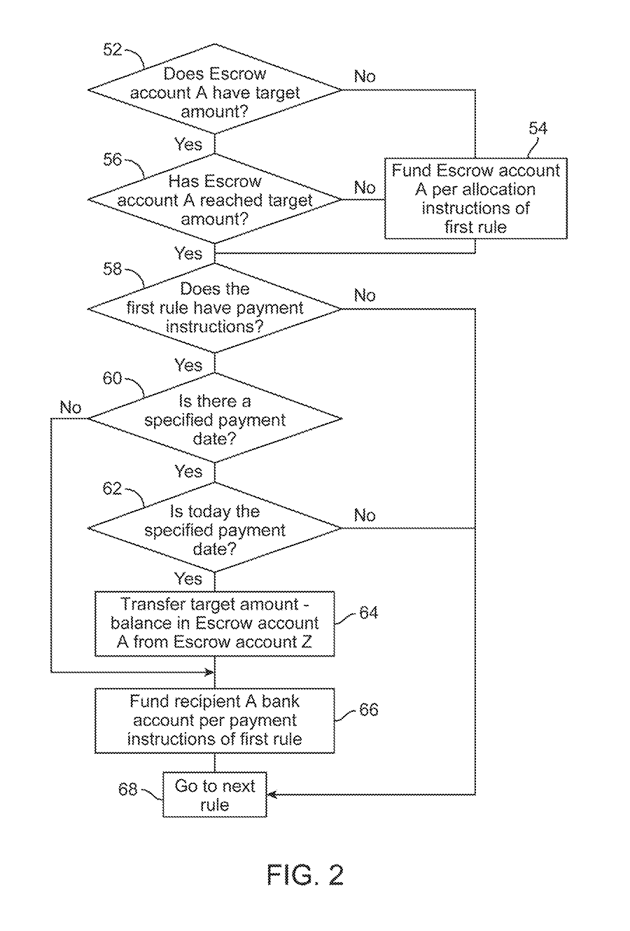

The system checks for the allocation rule from the first set of rules defined for escrow account A, at step 14. If, at step 14, the allocation instructions of the first rule are not applicable, as described in greater detail in FIG. 2, the system moves on to check for the second set of rules for the escrow account B, at step 22. If the allocation instructions of the first rule are applicable as seen in step 14, the first escrow account A will be allocated a percentage of the deposit, at step 16, in accordance with the allocation rule/instructions of the first rule. After the allocation instructions of the first rule have been applied at step 16, the system checks for payment transfer rule from the first set of rules for the escrow account A, at step 18. The balance may then be transferred to a recipient A bank account, at step 20, linked to escrow account A. The process continues to step 22 to check for the second set of rules for escrow account B.

If, at decision block 22, the allocation instructions of the second rule are not applicable, the system may skip steps 24, 26 and 28 and move to the next set of rules for next escrow account, at decision block 30. Otherwise, escrow account B will be allocated the percentage of the deposit at step 24 based on the funds allocation instructions from the second set of rules. The system may check for payment instructions from the second set of rules for the escrow account B, at step 26. The balance may then be transferred to a recipient B bank account linked to the escrow account B, at step 28, in accordance with the payment transfer rule or instructions specified by the second set of rules. The allocation and money transfer procedure continues for any additional escrow accounts, as explained above, until the escrow account Z is reached.

The system then checks for the funds allocation instructions of the last set of rules for the escrow account Z. If the funds allocation instruction of the last set of rules is applicable, at step 30, the last escrow account, escrow account Z will be allocated a percentage of the deposit, at step 32. After escrow account Z has been funded per the allocation rule, the system checks if the present date is the specified payment date. If not, the allocation and money transfer procedure stops, at step 36, and waits for the next deposit into the sweep account, at step 12. If, the present date is the specified payment date, the system inquires as to whether all higher priority escrow accounts have reached their respective target amounts, at step 38. If the higher priority escrow accounts have reached their respective target amounts, the escrow account Z is funded, at step 42, and the process may stop, at step 46. If not, the system transfers from the escrow account Z, the amount or funds each higher priority escrow account need to reach their respective target fund, at step 40.

After escrow account Z funds all higher priority escrow accounts, the system applies payment transfer rule from the last set of rules for the escrow account Z, at step 42 and the process then may stop at step 46.

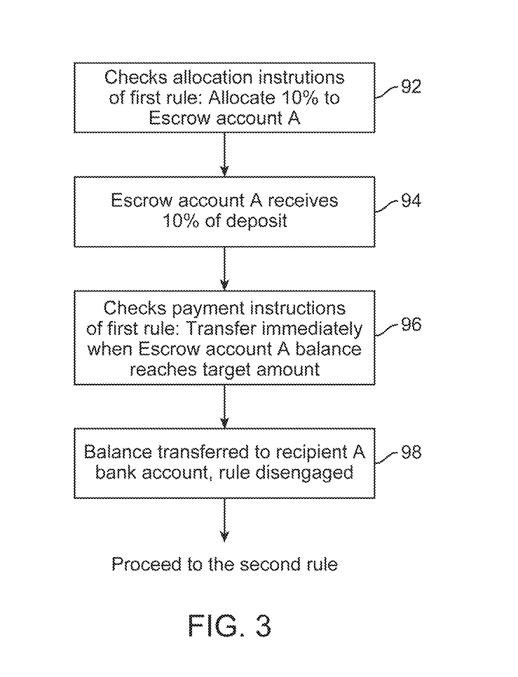

Additional details on the funds allocation and payment transfer method described at steps 14 through 20 will be described with reference to FIG. 2. Specific examples of allocation methods are described in the flow diagrams of FIG. 3 through FIG. 5 described below.

Referring to FIG. 2, there is shown a flow diagram illustrating detailed execution of a set of selectively repeating predefined rules corresponding to each of the sub-accounts or escrow accounts, according to an exemplary embodiment.

As seen, at step 52, the system inquires as to whether escrow account, for example escrow account A has a targeted funds or amount. If not, the escrow account A is funded as per the percentage specified in the funds allocation rule or instruction of the first set of rules defined for escrow account A, at step 54. Flow then proceeds to step 58 where the system checks if the first rule has payment transfer instructions. If on the other hand, there is a target amount specified for the escrow account A, the system inquires as to whether escrow account A has reached the targeted fund, at step 56. If the account has reached the targeted fund, the system does not carry out the first rule and proceeds to the next rule of the next escrow account, at step 68.

If, at step 56, it is determined that the specified targeted amount has not yet been reached for the escrow account A, the system applies the funds allocation rule and allocates the pre-determined percentage of the deposit assigned to the escrow account A, at step 54. If, at step 58, it is determined that there are no payment instructions in the first rule, the system proceeds to the next set of rules (to step 68). If, at step 58, it is determined there is payment transfer rule to be applied, the system inquires as to whether there is a specified payment date for transfer of the funds to recipient A bank account, at block 60. If, at step 60, there is payment instruction, but no specified payment date, funds are transferred from escrow account A to recipient A bank account immediately, at step 66. The system then proceeds to the next set of rules for next escrow account, at step 68. On the other hand, if a payment date has been specified, at step 60, the system inquires as to whether “today” is the payment date, at decision block 62. If not, the system proceeds to the next rule at step 68. If, at step 62, the system determines that payment is due on the present day, the recipient bank account A is funded in accordance with the first rule, at step 66, and the process continues to the next rule, at step 68.

Referring to FIG. 3, there is shown an example flow diagram illustrating a method for allocation and transfer of funds to a recipient on determining if the allocated funds have hit the allocated target. As seen at step 92, for example, the system applies the funds allocation rule from the first set of rules for escrow account A to the deposited funds in the sweep account. In this particular example, ten percent of deposits in the sweep bank account have been designated for transfer from escrow account A, at step 94. The payment transfer instructions of the first set of rules transfers funds from escrow account A to the bank account of recipient A when the balance in the escrow account A reaches a pre-determined target amount as shown in step 96. After the balance in escrow account A is transferred to the recipient A bank account as depicted in step 98, the system disengages the first set of rules from repetition. This type of transaction may be selected for a one-time payment to a recipient. For example, the users of the system may have retained legal counsel, and have elected to pay the counsel a specified amount of $5000. When the balance in the escrow account A reaches the amount of $5000, the entire amount is paid out to the legal counsel, the rule according to escrow account A payment transfer rule is disengaged, at step 98, and no further payments are made to the legal counsel. The process then proceeds to the next rule.

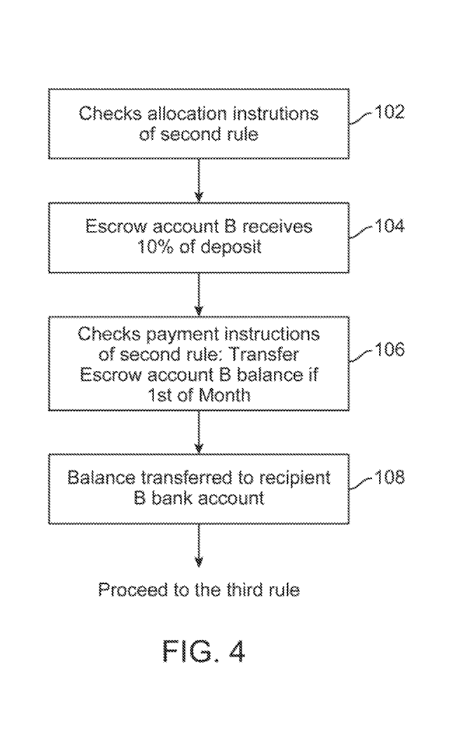

Referring to FIG. 4, there is shown an example flow diagram illustrating a method for allocation and transfer of funds to recipients on a scheduled date. As seen, at step 102, the system applies the funds allocation rule from the second set of rules for escrow account B to a deposit in the sweep account. In this particular example, ten percent of the deposit is transferred from the sweep bank account to escrow account B, at step 104. The system then checks for the payment transfer rule from the second set of rules, at step 106, which indicates transfer of the balance in the escrow account B on the 1st of the next month, at step 108. This sort of monthly payment arrangement is preferably used to funds a rent account from which money is used to pay rent for office space, for example. As seen, since the set of rule doesn't specify not to repeat the sequences of rules, this is an ongoing transaction; therefore the funds allocation rule and the payment transfer rule is executed each time money is deposited into the sweep account. Such an ongoing and immediate payment arrangement may be made for a licensor associated with the revenue stream funding the sweep bank account.

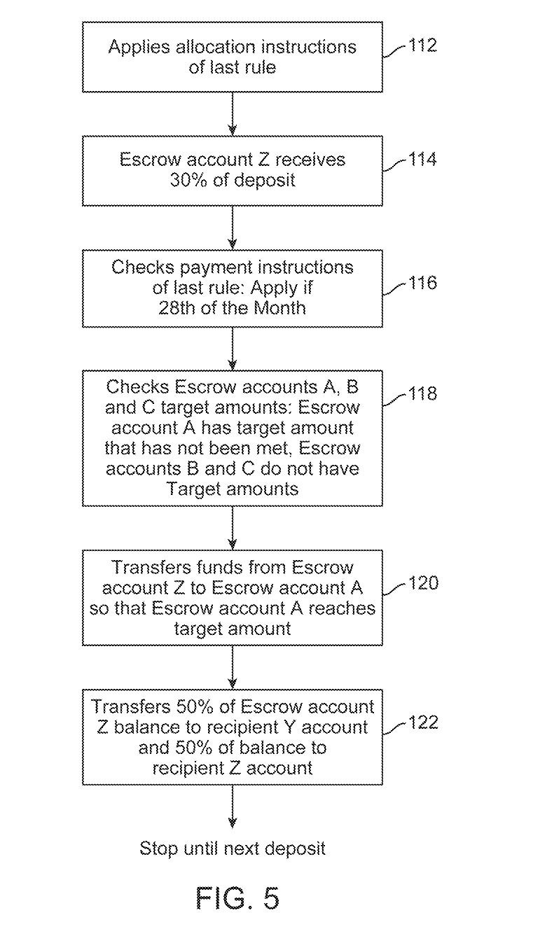

Referring to FIG. 5, an example flow diagram illustrating a method how a funds allocation rule enables a terminating sub-account of the sub-accounts to transfer funds into higher priority sub-accounts to ensure each of higher priority sub-accounts hit the allocated target fund. As seen, here the method move to the last set of rules for escrow account Z. For simplicity escrow account Z can be considered as partner escrow account, that means funds allocated to the escrow account Z are meant for distribution among the partners only after all higher priority escrow accounts have reached their targeted fund. This type of escrow account may be preferably assigned for partners in a business that employs current system to allocate profit and pay bills and licensor fees before taking their cut of the profit.

As seen, at step 112 and step 114, the system applies funds allocation rule from the last set of rules and allocates 30% of deposits into the sweep account to the escrow account Z. The system then checks for the payment transfer rule that is to be applied on the 28th of next month, at step 116, only after all escrow accounts except escrow account Z have hit targeted funds. The system then checks balance of escrow accounts A, B and C (for example, if we consider there are three higher priority escrow accounts) at step 118. In this case, if the escrow account A has a target amount that has not been met and the escrow accounts B and C do not have target amounts. The system then transfers funds from the escrow account Z to the escrow account A so that escrow account A reaches its target funding at step 120. The system continues applying the payment instructions at step 122. In this case, there are two recipient bank accounts linked to the escrow account Z, and the instructions specify that 50% of the balance in the escrow account Z is to be transferred to recipient Y bank account and 50% is transferred to recipient Z account. After checking and applying the last rule, the system stops until the next deposit is made in the sweep account.

With respect to the above description, it is to be realized that the optimum relationships for the components and steps in the invention, including variations in order, form, content, function and manner of operation, are deemed readily apparent and obvious to one skilled in the art, and all equivalent relationship to those illustrated in the drawings and described in the specification are intended to be encompassed by the present invention.

The above description and drawings are illustrative of modifications that can be made without departing from the scope of present invention. Therefore, the foregoing is considered as illustrative only of the principles of the invention. Further, since numerous modifications and changes will readily occur to those skilled in the art, it is not desired to limit the invention to be exact construction and operation shown and described, and accordingly, all suitable modifications and equivalents are intended to fall within the scope of the invention as claimed.

We claim:

1. A method for controlling allocation and transfer of funds among a plurality of recipients, said method comprising the steps of:
receiving, at a web server, a plurality of registration information from a user;
storing, in one or more databases said registration information associated with said user, wherein each of said databases being communicatively linked to said web server;
assigning, to said user a primary account, and a plurality of sub-accounts communicatively linked with said primary account in a waterfall hierarchy;
receiving from said user, at least one recipient account information to be linked to each of said sub-accounts;
receiving from said user, a set of selectively repeating predefined rules corresponding to each of said sub-accounts, wherein said set of predefined rules including at least one of:
a funds allocation rule for allocating a portion of funds deposited in said primary account into each of said sub-accounts until the funds deposited in said primary account is fully allocated, and determining if allocated funds has hit the allocated target for each of said sub-accounts,
a payment transfer rule for transferring the allocated target funds in each of said sub-accounts to said recipient account based on at least one said determination, and a predetermined scheduled date, and
an authentication verification rule for verifying authentication of said user for selectively updating said set of predefined rules corresponding to each of the sub-accounts.

2. The method of claim 1, wherein said step of receiving said registration information comprises receiving user identification information.

3. The method of claim 1 further comprising a step of assigning user authentication information to said user upon registration with said web server, wherein said user authentication information includes one or more of: a username, a password, and a PIN.

4. The method of claim 1, wherein said primary account being configured to receive funds from one or more payment sources comprises at least one of a prepaid card, a debit card, a credit card, and bank account.

5. The method of claim 1, wherein said recipient account information is related to one or more of: an individual, a business, and an organization.

6. The method of claim 1, wherein said primary account provided by the web server serves to automatically transfer funds into each of said sub accounts linked thereof based on said funds allocation rule.

7. The method of claim 1, wherein said determination if allocated funds has hit the allocated target for each of said sub-accounts either (i) terminate further allocation of funds in each of said sub-accounts or (ii) repeats said funds allocation rule each time a funds is deposited in said primary account.

8. The method of claim 1, wherein said funds allocation rule further enables a terminating sub-account of said plurality of sub-accounts to transfer funds into one or more higher priority sub-accounts to ensure each of higher priority sub-accounts hit the allocated target fund.

9. The method of claim 1, wherein said authentication verification rule when implemented performing following operations:
transmits a message comprising a randomly generated verification code to at least one of said registered user, and one or more users authorized to update said set of predefined rules corresponding to each of the sub-accounts,
receives response to said message from said registered users and said users authorized to update said set of predefined rules,
maps the responses received from each of said registered users and said users authorized to update said set of predefined rules for compliance with the authentication verification rule, and
allows said registered users and said authorized users to update said set of predefined rules on determining compliance.

10. A method for distributing funds among a plurality of recipients, the method being carried out by a number of different entities, including a web server executing a web application configured thereon, one or more databases communicatively linked to said web server, a computing device for accessing said server presenting a plurality of visualizations for display on said computing device, with each of the entities communicating over a communication network, the method comprising the following steps:
receiving, at a web server, a plurality of registration information from a user;
storing, in one or more databases said registration information associated with said user, wherein each of said databases being communicatively linked to said web server;
assigning, to said user a primary account, and a plurality of sub-accounts communicatively linked with said primary account in a waterfall hierarchy;
receiving from said user, at least one recipient account information to be linked to each of said sub-accounts;
receiving from said user, a set of selectively repeating predefined rules corresponding to each of said sub-accounts, wherein said set of predefined rules comprising at least one of:
a funds allocation rule for allocating a portion of funds deposited in said primary account into each of said sub-accounts until the funds deposited in said primary account is fully allocated, and determining if allocated funds has hit the allocated target for each of said sub-accounts,
a payment transfer rule for transferring the allocated target funds in each of said sub-accounts to said recipient account based on at least one said determination, and a predetermined scheduled date, and
an authentication verification rule for verifying authentication of said user for selectively updating said set of predefined rules corresponding to each of the sub-accounts.

11. The method of claim 10, wherein said step of receiving said registration information comprises the step of receiving user identification information.

12. The method of claim 10, wherein said primary account being configured to receive funds from one or more payment sources comprises at least one of a prepaid card, a debit card, a credit card, and a bank account.

13. The method of claim 10, wherein said primary account provided by said web server serve to automatically transfer funds into each of said sub accounts linked thereof based on said funds allocation rule.

14. The method of claim 10, wherein said determination, if allocated funds has hit the allocated target funds for each of said sub-accounts either (i) terminates further allocation of funds in each of said sub-accounts or (ii) repeats said funds allocation rule each time a funds is deposited in said primary account.

15. The method of claim 10, wherein said funds allocation rule further enables a terminating sub-account of said plurality of sub-accounts to transfer funds into one or more higher priority sub-accounts to ensure each of said higher priority sub-accounts hits the target allocated fund.

16. The method of claim 10, wherein said authentication verification rule, when implemented, performs the following operations: (i) transmitting a message comprising a randomly generated verification code to at least one of said registered user, and one or more users authorized to update said set of predefined rules corresponding to each of the sub-accounts, (ii) receiving a response to said message from said registered users and said users authorized to update said set of predefined rules, (iii) mapping the responses received from each of said registered users and said users authorized to update said set of predefined rules for compliance with the authentication verification rule, and (iv) allowing said registered users and said authorized users to update said set of predefined rules on determining compliance.

17. A system, comprising:
a web server including a data processor, and a computer readable memory having computer readable instructions encoded therein that, when executed by said data processor, presents a plurality of visualizations for display on a computing device associated with a user;
one or more databases communicatively linked to said web server for storing a plurality of registration information received from said user;
wherein each of said visualizations depicting a method for distributing funds among a plurality of recipients, said method performing following operations:
assigning to said user, a primary account, and a plurality of sub-accounts communicatively linked with said primary account in a waterfall hierarchy,
receiving from said user, at least one recipient account information to be linked to each of said sub-accounts,
receiving from said user, a set of selectively repeating predefined rules corresponding to each of said sub-accounts, wherein said set of predefined rules includes at least one of:
a funds allocation rule for allocating a portion of funds deposited in said primary account into each of said sub-accounts until the funds deposited in said primary account are fully allocated, and determining if allocated funds has hit the allocated target for each of said sub-accounts,
a payment transfer rule for transferring the allocated target funds in each of said sub-accounts to said recipient account based on at least one said determination, and a predetermined scheduled date, and
an authentication verification rule for verifying authentication of said user for selectively updating said set of predefined rules corresponding to each of the sub-accounts.

18. The system of claim 17, wherein said determination, if allocated funds has hit the target allocated for each of said sub-accounts, either (i) terminates further allocation of funds in each of said sub-accounts or (ii) repeats said funds allocation rule each time funds are deposited in said primary account.

19. The system of claim 17, wherein said funds allocation rule further enables a terminating sub-account of said plurality of sub-accounts to transfer funds into one or more higher priority sub-accounts to ensure each of higher priority sub-accounts hits the target allocated fund.

20. The system of claim 17, wherein said authentication verification rule when implemented performing following operations: (i) transmitting a message comprising a randomly generated verification code to at least one of said registered user, and one or more users authorized to update said set of predefined rules corresponding to each of the sub-accounts, (ii) receiving a response to said message from said registered users and said users authorized to update said set of predefined rules, (iii) mapping the responses received from each of said registered users and said users authorized to update said set of predefined rules for compliance with the authentication verification rule, and (iv) allowing said registered users and said authorized users to update said set of predefined rules on determining compliance.
